(19) United States
(12) Patent Application Publication
(10) Pub. No.: US 2012/0318370 A1
(43) Pub. Date: Dec. 20, 2012

(54) PROCESS AND ARRANGEMENT FOR RECOVERING FLUID FROM A SHIP WRECK

(75) Inventors: Geert Jan Jacob VERVER, Delft (NL); Bart Maarten Willem HUIZING, Midlaren (NL)

(73) Assignee: SMIT NEDERLAND B.V., Rotterdam (NL)

(21) Appl. No.: 13/494,155

(22) Filed: Jun. 12, 2012

(30) Foreign Application Priority Data
Jun. 14, 2011 (EP) 11169824.7

(51) Int. Cl. F17D 1/16; F16L 53/00

(52) U.S. Cl. 137/13; 137/334

(57) ABSTRACT

An arrangement for recovering oil from a sunken ship wreck (1) resting on the bottom (2) of a body of water, which wreck including a compartment (3) with contains a fluid, such as bunker oil or cargo oil, includes first stage heating elements (10) immersed in the fluid in the compartment (3), second stage heating elements (11) outside the wreck (1) and connected to the compartment (3) according to a fluid circulation loop (6). Furthermore, a fluid transfer line (9) is connected to the fluid circulation loop (6). Selector valve elements (20) are connected the fluid circulation loop (6) and the fluid transfer line (9) for selectively allowing fluid flow through the fluid circulation loop and/or the fluid transfer line.

The invention is related to the field of recovering fluids, such as bunker oil or crude oil, from a tank or compartment of a sunken ship. The recovery of such fluids is highly desirable for avoiding spills and environment pollution. Although a fluid such as oil may remain locked within the ship wreck during prolonged periods, it cannot be excluded that in the end still leakage will occur. This may be the result of deterioration of the tank construction over time, for instance due to corrosion. Also, the influence of tidal currents and waves may in the long run lead to tank collapse and oil spill.

As a first measure, it is therefore attempted to empty the tank or compartment in question as much as possible. Having regard to ever more stringent demands which are issued for reasons of maintaining the environment, it has become also desirable to recover fluids from ship wrecks which have been left on the sea bottom without removing the oil and the like from the wreck.

Due to the fact that the fluids to be recovered are located at the bottom of a body of water, the temperature thereof is generally low, resulting in high viscosities. The temperature prevailing at the sea bottom is generally much lower than the pour point temperature of the fluid, which means that is difficult if not impossible to transport the oil. In this connection, it has been proposed to heat the oil in the tank. According to EP-A-1143074, heating of the oil in a sunken ship is carried out by supplying a high-frequency current to a working coil in the tank. The oil in question is heated locally; as a result of the rather low natural heat diffusion of oil however, it would thus take a prolonged period of time before a reasonable amount of oil is heated to such an extent that it may be pumped from the tank.

WO-A-9525955 discloses an integrated injector and eductor assembly whereby heat is produced in the oil cargo of a sunken ship. Said assembly is introduced through the tank wall and into the oil. In a gradual fashion, the heated part of the cargo becomes larger and is emulsified so as to pump it away. Apart from the disadvantage that such process is time consuming, measures have to be taken to separate the oil out of the emulsion after recovery.

The object of the invention is to provide a process for recovering a fluid from a sunken ship which can be carried out in an expedient and efficient manner. This object is achieved through a process for recovering a fluid, such as bunker oil or cargo oil, from a sunken ship wreck resting on the bottom of a body of water, comprising the steps of heating the fluid and subsequently pumping the heated fluid to a reservoir at the surface of the body of water, said process furthermore comprising the steps of:
applying first stage heating means within the wreck,
applying second stage heating means outside the wreck,
making the fluid circulate through the first and the second heating means,
completing at least on full circulation cycle during which the fluid is heated by both the first and the second heating means,
pumping the fluid to a collection reservoir after completing at least said one full circulation cycle.

In the process according to the invention, initially the step of heating the fluid within the tank or compartment in the ship is carried out through the first stage heating means. Thus, a relatively small amount of fluid is heated and thus becomes readily flowable. Next, the heated fluid is circulated towards the second stage heating means so as to add further heat and to further increase the temperature thereof. The fluid is then fed back into the tank, where it heats the remaining fluid together with the first stage heating means. A further advantage of the circulation thus obtained is that the largest part of the fluid in the tank is heated by mixing with the relatively warm circulation fluid, as a result of which virtually the complete fluid load will reach the temperature desired for pumping.

Preferably, the heating is carried out through steam or superheated water. A fluid such as oil may be subsequently pumped to the surface after a batch thereof has reached at least a temperature at which the fluid is pumpable. Thus, the oil may be pumped to a collection reservoir, for instance at the surface or a subsea reservoir, according to several subsequent batches.

The invention is furthermore related to an arrangement for carrying out the method as described before, comprising a sunken ship wreck resting on the bottom of a body of water, said wreck comprising a compartment which contains a fluid, such as bunker oil or cargo oil, first stage heating means immersed in the fluid in the compartment, second stage heating means outside the wreck and connected to the compartment according to a fluid circulation loop, a fluid transfer line connected to the fluid circulation loop and selector valve means connected the fluid circulation loop and the fluid transfer line for selectively allowing fluid flow through the fluid circulation loop and/or the fluid transfer line.

Once the several components of the arrangement have been installed and the circulation flow of fluid has been established, it is a matter of time to spread the heat over the full volume within the tank. Gradually, the largest part of this volume thus obtains a temperature which is sufficient to allow the oil to flow and to be pumped to the surface.

Preferably, the heating means each comprise a heat exchanger connected to respective feed and discharge lines for steam or superheated water. As a result of the heating process, a pressure differential may develop between the volume in the tank and the environment. In order to prevent overpressure, an expansion vessel may be connected to the circulation loop. With the aim of preventing underpressure in the tank, a check valve may be provided in the circulation loop for preventing backflow from the tank towards the second stage heating means

The invention is furthermore related to novel first stage heating means for use in the method as described before. The first stage heating means comprise a heating and circulation unit having a frame, hull mounting means for mounting the frame on a ship wreck hull, and a heat exchanger which is displaceable in a sealed fashion with respect to the frame between a retracted position and an extended position. Before installing the first stage heating means, a hole is to be drilled in the wall of the compartment or tank. Subsequently, the frame is connected to said wall by the hull mounting means, such as a flange which is bolted onto the area surrounding the hole. Next, the heat exchanger can be extended out of the frame and into the oil in the compartment or fluid.

With the aim of preventing the oil from leaking out of the tank through the hole in the wall thereof, the frame may comprise a tubular member within which the heater element is displaceable in a sealing fashion, and a mounting flange at the inlet opening of the tubular member for sealing connection to the ship wreck hull. For the purpose of supplying heat, the heat exchanger may comprise an inlet and a discharge for steam or superheated water.

Preferably, a platform is provided which may be positioned on the seabed near the ship wreck. Said platform may carry the second stage heating means and may be connected to the transfer line, the heating lines as well as control umbilicals for controlling the circuit. This connection preferably comprises a connector which can be remotely controlled. Alternatively, the connector could be operated by a diver by ROV.

Thereby, the transfer line, heating lines and umbilicals may be disconnected remotely from the platform in the case of an emergency. The circulation loop however is kept closed, in such a way that no fluid spill will occur in the case of such emergency. Subsequently, the connection between the platform and the several lines and umbilicals can be made up again to resume the oil recovery activities.

Depending on the size of the tank or compartment, several, e.g. two, heating and circulation units may be applied which are positioned at some distance from each other. Thereby, the process of heating of the oil cargo to a suitable temperature may be increased even further. Preferably, the several heating and circulation units are arranged in parallel with respect to the second stage heating means.

Furthermore, the heating and circulation unit may comprise a conduit which at one end emanates at the hull mounting means in fluid communication with the compartment and which at the other end is in fluid communication with a circulation hose or pipe connected to the second stage heating means. In this way, the unit not only serves the purpose of heating the fluid in the tank, but also the purpose of circulating the heated oil out of the tank through the conduit. This conduit may be arranged around the frame, e.g. in a concentric fashion.

The invention is also related to a heating and circulation unit per se for use in the arrangement described before, comprising a frame, hull mounting means for mounting the frame on a ship wreck hull, and a heat exchanger which is displaceable in a sealed fashion with respect to the frame between a retracted position and an extended position. In particular, the frame may comprise a tubular member. The heater element may be displaceable within the tubular member in a sealing fashion. A mounting flange may be provided at the inlet opening of the tubular member for sealing connection to the ship wreck hull. Additionally, a conduit may be provided which at one end emanates at the hull mounting means and which at the other comprises flange means for establishing fluid communication with a circulation hose or pipe.

The invention will now be described further with reference to the drawings.

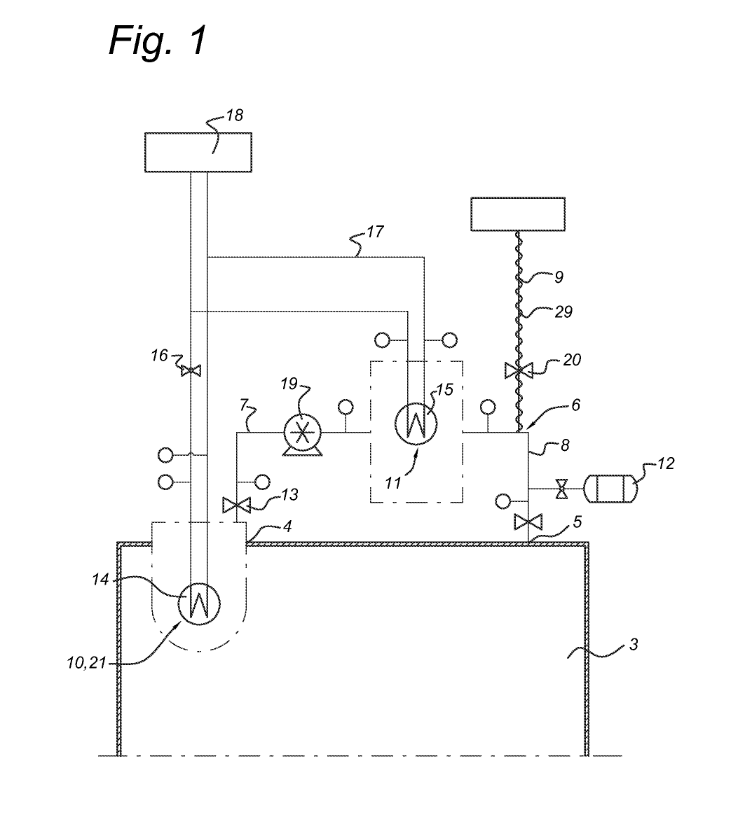

FIG. 1 shows a flow scheme of the arrangement according to the invention.

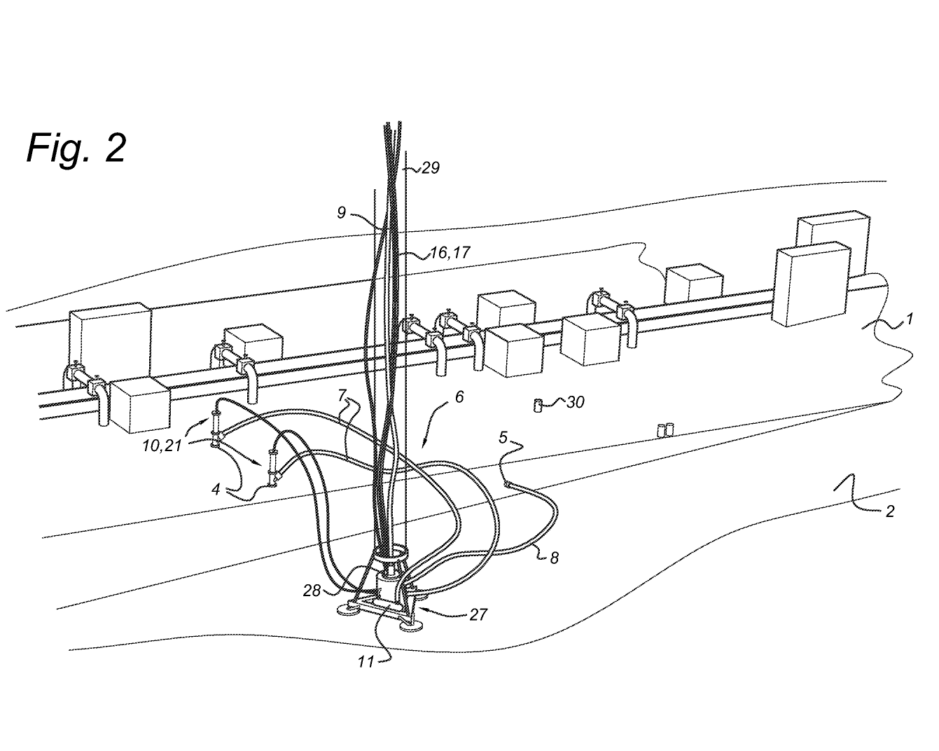

FIG. 2 shows an artist impression of the arrangement.

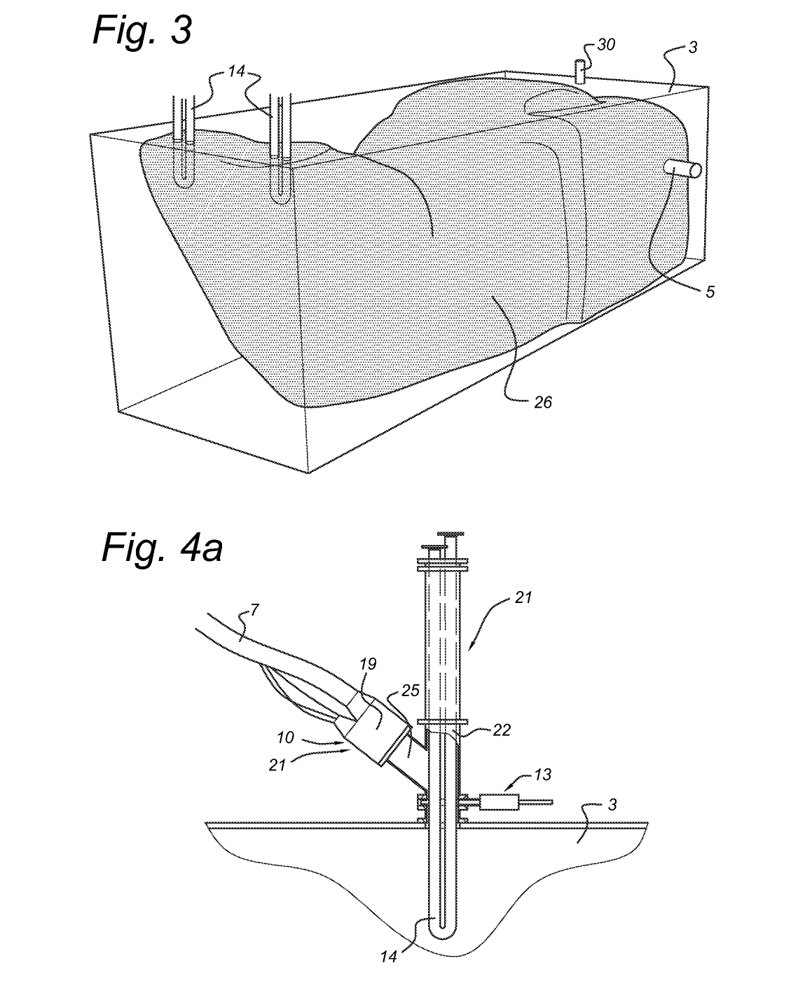

FIG. 3 shows a view in perspective of the heated fluid in a tank.

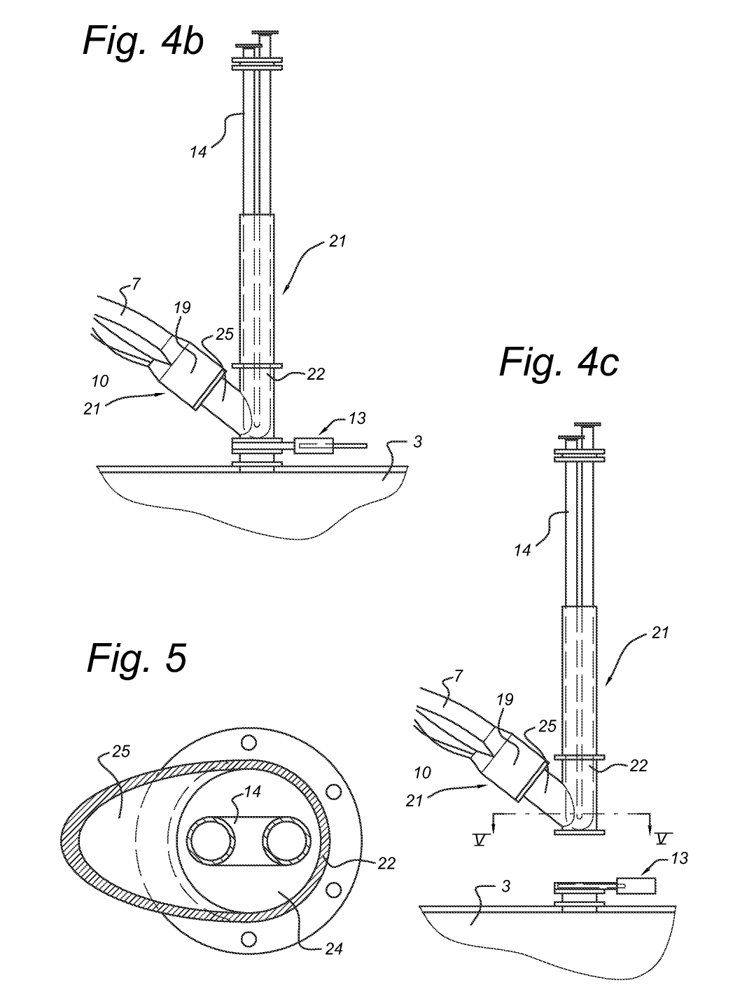

FIGS. 4a, b, c show several stages in the process of applying the first stage heating means.

FIG. 5 shows the cross section according to V-V of FIG. 4.

FIG. 2 shows a ship wreck 1 lying on the bottom 2 of a body of water. Within the ship wreck, oil tanks 3 are located. These tanks are accessed from the outside by drilling discharge holes 4. In the embodiment shown in FIG. 2, two discharge holes 4 have been provided, although one discharge hole or more tan two of such discharge holes 4 may be provided as well, dependent on the size of the tank 3. Furthermore, a feed hole 5 has been drilled in the tank. Also, more than one feed hole may be present.

Through the discharge holes 4, first stage heating means 10 have been introduced into the tank 3. Oil which is heated by the first stage heating means 10 is fed through lines 7 to a second stage heating means 11 located outside the ship wreck. From the second stage heating means 11, the fluid is fed back into the tank 3 through the feed line 8. The discharge holes 3, feed hole 4, discharge lines 7, feed line 8, first stage heating means 10, second stage heating means 11, pump 19 and tank 3 together form part a circulation circuit 6 which enables a gradual heating of the fluid within the tank 3.

The circulation circuit 6 is connected to an expansion vessel 12 so as to prevent the build up of overpressure within the tank 3 during the heating process. Furthermore, valves 13 have been installed between the first stage heating means 10 and the tank 3. A check valve 30 is connected to the tank 3 for allowing water to flow into the tank for preventing underpressure in the tank. The heating means 10, 11 each comprise heat exchangers 14, 15 which are fed with superheated water or steam from the heating source 18 through respective lines 16, 17. Once the fluid has been heated up to a sufficient degree, a large amount of flowable fluid is obtained within the tank 3, as depicted in FIG. 3. The shape of the flowable oil amount depends on the positions of the heating means 10, 11. The transfer valve 20 is opened and a batch of the heated fluid is fed through transfer line 20, e.g. towards the surface of the body of water and collected in a suitable vessel for further handling.

The secondary heating means 11 can be carried out as a pipe heat exchanger. The primary heat exchanger 10 comprises a heating and circulation unit 21, as shown in FIGS. 4-c. This heating and circulation unit 21 has a tubular frame 22, which at one end carries a mounting flange 23 which can be connected onto the valve 13. Within the tubular frame, the heat exchanger 14 is displaceable in a sealing fashion, between the extended position shown in FIG. 4a, and the retracted position shown in FIGS. 4b, c. The tubular frame 22 moreover constitutes a conduit 24, which at the mounting flange is in fluid communication with the tank. The tubular frame has a branch 25 onto which the discharge tube 7 has been mounted for discharging heated fluid from the tank 3.

The second stage heating means 11 are accommodated on a platform 27 which is positioned next to the ship wreck 1. The platform has a connector 28 through which the transfer line 9, the heating lines 16, 17 as well as control umbilicals 29 for controlling the circulation circuit 6 are connected to said circuit. In the case of emergency conditions or otherwise, such connector may be released without disrupting the closed character of said circulation circuit 6.

Although the pump 19 is shown mounted on the branch 19 of the heat and circulation unit 21, alternatives are possible as well, such as a connection through an intermediary hose.

### LIST OF REFERENCE NUMERALS

1. Ship wreck
2. Sea bottom
3. Tank
4. Discharge hole
5. Feed hole
6. Circulation circuit
7. Discharge tube
8. Feed tube
9. Transfer hose
10. First stage heating means
11. Second stage heating means
12. Expansion vessel
13. Valve
14. Heating coil
15. Pipe heat exchanger
16. Heating lines
17. Heating lines
18. Heat source
19. Pump
20. Selector valve
21. Heating and circulation unit
22. Tubular frame
23. Mounting flange
24. Conduit
25. Branch
26. Heated fluid
27. Platform
28. Connector
29. Umbilicals
30. Check valve

1. Process for recovering a fluid, such as bunker oil or cargo oil, from a sunken ship wreck (1) resting on the bottom (2) of a body of water, comprising the steps of heating the fluid and subsequently pumping the heated fluid to a reservoir at the surface of the body of water, said process furthermore comprising the steps of:
applying first stage heating means (10) within the wreck (1),
applying second stage heating means (11) outside the wreck (1),
making the fluid circulate through the first and the second heating means,
completing at least on full circulation cycle during which the fluid is heated by both the first and the second heating means,
pumping the fluid to a collection reservoir after completing at least said one full circulation cycle.

2. Process according to claim 1, comprising the step of heating the fluid through steam or superheated water.

3. Process according to claim 1, comprising the step of pumping oil to the collection reservoir after a batch thereof has reached at least a temperature at which the fluid is pumpable.

4. Process according to claim 1, comprising the step of pumping the oil to the collection reservoir according to several subsequent batches.

5. Arrangement for carrying out the method according to claim 1, comprising a sunken ship wreck (1) resting on the bottom (2) of a body of water, said wreck comprising a compartment (3) which contains a fluid, such as bunker oil or cargo oil, first stage heating means (10) immersed in the fluid in the compartment (3), second stage heating means (11) outside the wreck (1) and connected to the compartment (3) according to a fluid circulation loop (6), a fluid transfer line (9) connected to the fluid circulation loop (6) and selector valve means (20) connected the fluid circulation loop (6) and the fluid transfer line (9) for selectively allowing fluid flow through the fluid circulation loop and/or the fluid transfer line.

6. Arrangement according to claim 5, wherein the first stage heating means (10) comprises at least one heating and circulation unit (21) with a frame (22), hull mounting means (23) by means of which the frame is mounted on a ship wreck hull (1), and a heat exchanger (14) which is displaceable in a sealed fashion with respect to the frame (22) between a retracted position and an extended position.

7. Arrangement according to claim 6, wherein the heating and circulation unit (21) comprises a conduit (24) which at one end emanates at the hull mounting means (23) in fluid communication with the compartment (3) and which at the other end is in fluid communication with a circulation hose or pipe (7) connected to the second stage heating means (11).

8. Arrangement according to claim 7, comprising at least two heating and circulation means (21) which are connected in parallel to the second stage heating means (11).

9. Arrangement according to claim 5, wherein heating means (10, 11) each comprise a heat exchanger connected to respective feed and discharge lines (16, 17) for steam or superheated water.

10. Arrangement according to claim 5, wherein an expansion vessel (12) is connected to the circulation loop (6).

11. Arrangement according to claim 5, wherein the circulation loop (6) comprises a pump (19).

12. Arrangement according to claim 5, wherein a platform (27) is provided which carries the second stage heating means (11), the transfer line (20), heating lines (16, 17) as well as umbilicals (28) for controlling the circuit (6) being connected to the platform (27) through a remotely controlled connector (29).

13. Heating and circulation unit (21) for use in the arrangement according to claim 6, comprising a frame (22), hull mounting means (23) for mounting the frame on a ship wreck hull (1), and a heat exchanger (14) which is displaceable in a sealed fashion with respect to the frame (22) between a retracted position and an extended position.

14. Heating and circulation unit (21) according to claim 13, wherein the frame comprises a tubular member (22), the heat exchanger (14) being displaceable within the tubular member in a sealing fashion, and a mounting flange (23) at the inlet opening of the tubular member for sealing connection to the ship wreck hull (1).

15. Heating and circulation unit (21) according to claim 13, comprising a conduit (24) which at one end emanates at the hull mounting means (23) and which at the other end comprises coupling means (25) for establishing fluid communication with a circulation hose or pipe (7).

16. Heating and circulation unit (21) according to claim 14, comprising a conduit (24) which at one end emanates at the hull mounting means (23) and which at the other end comprises coupling means (25) for establishing fluid communication with a circulation hose or pipe (7).

17. Process according to claim 2, comprising the step of pumping oil to the collection reservoir after a batch thereof has reached at least a temperature at which the fluid is pumpable.
